(19) United States
(12) Patent Application Publication
(10) Pub. No.: US 2025/0188790 A1
(43) Pub. Date: Jun. 12, 2025

(54) METHOD FOR CONTROLLING DOORS OF A VEHICLE, VEHICLE-MOUNTED DEVICE, AND STORAGE MEDIUM

(71) Applicant: HON HAI PRECISION INDUSTRY CO., LTD., New Taipei (TW)

(72) Inventor: WAN-CHEN WU, New Taipei (TW)

(21) Appl. No.: 18/736,438

(22) Filed: Jun. 6, 2024

(30) Foreign Application Priority Data
Dec. 6, 2023 (CN) 202311665743.6

(51) Int. Cl. E05F 15/75; E05F 15/40

(52) U.S. Cl. CPC E05F 15/75; E05F 15/40; E05Y 2900/531

(57) ABSTRACT

A method for controlling doors of a vehicle, a vehicle-mounted device and a storage medium are provided. In the method, in response that a vehicle stops moving, and/or a user in the vehicle has an intention to open a door of the vehicle, determines whether there is an obstacle in a target area of the vehicle. In response that there is an obstacle in the target area of the vehicle, obstacle information of the obstacle is obtained. A target door corresponding to the obstacle is determined. A damping force is applied to the target door by controlling a damper corresponding to the target door according to the obstacle information. By utilizing the method, vehicle collision accidents can be reduced.

### FIELD

The present application relates to an intelligent vehicle technology, specifically a method for controlling doors of a vehicle, a vehicle-mounted device and a storage medium.

### BACKGROUND

Generally, when a user opens a door of a vehicle, the user might not pay attention to surrounding environment of the vehicle. Thus, a door may crash into obstacles or moving objects (e.g., pedestrians, vehicles), and may even cause a traffic accident. Some vehicles are equipped with a door opening warning system that outputs sound or light warning when the door opening warning system detects a collision. However, if music is being played in a high volume in the vehicle, or passengers are on a phone call, or the passengers simply do not notice the warning sound or warning light, the passengers in the vehicle may not receive warning signals in time.

### BRIEF DESCRIPTION OF THE DRAWINGS

FIG. 1 shows a schematic diagram of a vehicle-mounted device provided in an embodiment of the present application.

FIG. 2 shows a flowchart of a method for controlling doors of a vehicle provided in an embodiment of the present application.

FIG. 3 shows a first flowchart of a method for determining an intention to open a vehicle door provided in an embodiment of the present application.

FIG. 4 shows a second flowchart of a method for determining the intention to open the vehicle door provided in an embodiment of the present application.

FIG. 5 shows a first diagram of a first preset damping force in an embodiment of the present application.

FIG. 6 shows a second diagram of the first preset damping force in an embodiment of the present application.

FIG. 7 shows a first diagram of a second preset damping force in an embodiment of the present application.

FIG. 8 shows a second diagram of a third preset damping force in an embodiment of the present application.

### DETAILED DESCRIPTION

The accompanying drawings combined with the detailed description illustrate the embodiments of the present application hereinafter. It is noted that embodiments of the present disclosure and features of the embodiments can be combined, when there is no conflict.

Various details are described in the following descriptions for a better understanding of the present application, however, the present application may also be implemented in other ways other than those described herein. The scope of the present application is not to be limited by the specific embodiments disclosed below. Unless defined otherwise, all technical and scientific terms used herein have the same meaning as commonly understood by one of ordinary skill in the art to which the present application belongs. The terms used herein in the present application are only for the purpose of describing specific embodiments and are not intended to limit the present disclosure.

Generally, when a user opens a door of a vehicle, the user would not pay attention to surrounding environment of the vehicle. Thus, a door may be crashed to obstacles or moving objects (e.g., pedestrians, vehicles), and a traffic accident is occurred. Some vehicles are equipped with a door opening warning system that outputs sound or light warning when the door opening warning system detects a collision. However, when the music volume in the vehicle is too loud, passengers are in a phone call, or passengers do not notice the sound or light warning, the passengers in the vehicle may not receive warning signals in time. Thus, vehicle collision accidents cannot be effectively avoided.

The present application provides a method for controlling doors of a vehicle, a vehicle-mounted device and a storage medium. The present application can effectively reduce the door collision accidents caused by the user opening a door. The method for controlling doors of a vehicle provided in some embodiments of this present application can be applied to one or more vehicle-mounted devices.

FIG. 1 is a schematic structural diagram of a vehicle-mounted device provided in an embodiment of the present application. As shown in FIG. 1, a vehicle-mounted device 10 includes, but is not limited to, an Electronic Control Unit (ECU), or a Body Control Module (BCM). Types of the vehicle-mounted device are not limited in any embodiment.

As shown in FIG. 1, The vehicle-mounted device 10 may include a communication module 101, a storage device 102, a processor 103, an input/output (I/O) interface 104 and a bus 105. The processor 103 is coupled to the communication module 101, the storage device 102, and the I/O interface 104 through the bus 105, respectively.

The communication module 101 may include a wired communication module and/or a wireless communication module. The wired communication module can provide one or more of wired communication solutions such as Universal Serial Bus (USB), Controller Area Network (CAN), Local Interconnect Network (LIN), FlexRay, for example. The wireless communication module can provide one or more of wireless communication solutions such as wireless fidelity (Wi-Fi), Bluetooth (BT), mobile communication network, frequency modulation (FM), near field communication (NFC), infrared technology.

The storage device 102 may include one or more random access memories (RAM) and one or more non-volatile memories (NVM). The random access memory can be directly read and written by the processor 103. The random access memory can be used to store executable programs (such as machine instructions) of an operating system or other application programs, and can also be used to store user data and application data, for example. The random access memory can include static random-access memory (SRAM), dynamic random access memory (DRAM), synchronous dynamic random access memory (SDRAM), double data rate synchronous dynamic random access memory (DDR SDRAM), for example.

The non-volatile memory can also store executable programs, user data and application data, and the non-volatile memory can be loaded into the random access memory in advance for directly reading and writing by the processor 103. The non-volatile memory can include disk storage devices and flash memory.

The storage device 102 is used to store one or more computer programs. The one or more computer programs are configured for execution by the processor 103. The one or more computer programs include a plurality of instructions. The plurality of instructions can be executed by the processor 103 for implementing the method for controlling doors of a vehicle executed on the vehicle-mounted device 10.

In other embodiments, the vehicle-mounted device 10 further includes an external memory interface for connecting to an external memory to expand a storage capacity of the vehicle-mounted device 10.

The processor 103 may include one or more processing units. For example, the processor 103 may include an application processor (AP), a modem processor, a graphics processing unit (GPU), and an image signal processor (ISP), controller, video codec, digital signal processor (DSP), baseband processor, and/or neural network processing unit (NPU), for example. Different processing units can be independent devices or integrated in one or more processors.

The processor 103 provides computing and control capabilities. For example, the processor 103 is used to execute a computer program stored in the storage device 102 to implement the method for controlling doors of a vehicle.

The I/O interface 104 is used to provide a channel for user input or output. For example, the I/O interface 104 can be used to connect various input and output devices, such as a mouse, keyboard, touch device, display screen, etc., so that the user can input information. The I/O interface 104 can be used to visualize information.

The bus 105 is at least used to provide a communication channel between the communication module 101, the storage device 102, the processor 103, and the I/O interface 104 in the vehicle-mounted device 10.

It can be understood that a structure illustrated in the embodiment of the present disclosure does not constitute a specific limitation on the vehicle-mounted device 10. In other embodiments of the present disclosure, the vehicle-mounted device 10 may include more or less components than shown in the figures, or some components may be combined, some components may be separated, or some components may be arranged differently. The components illustrated may be implemented in hardware, software, or a combination of software and hardware.

In other embodiments of this application, the vehicle-mounted device 10 can also be replaced by an electronic device that can realize vehicle control. The electronic devices include, but are not limited to, a mobile phone, a tablet, a laptop, a computer, for example. The electronic devices are not specifically limited in this embodiment of the present application.

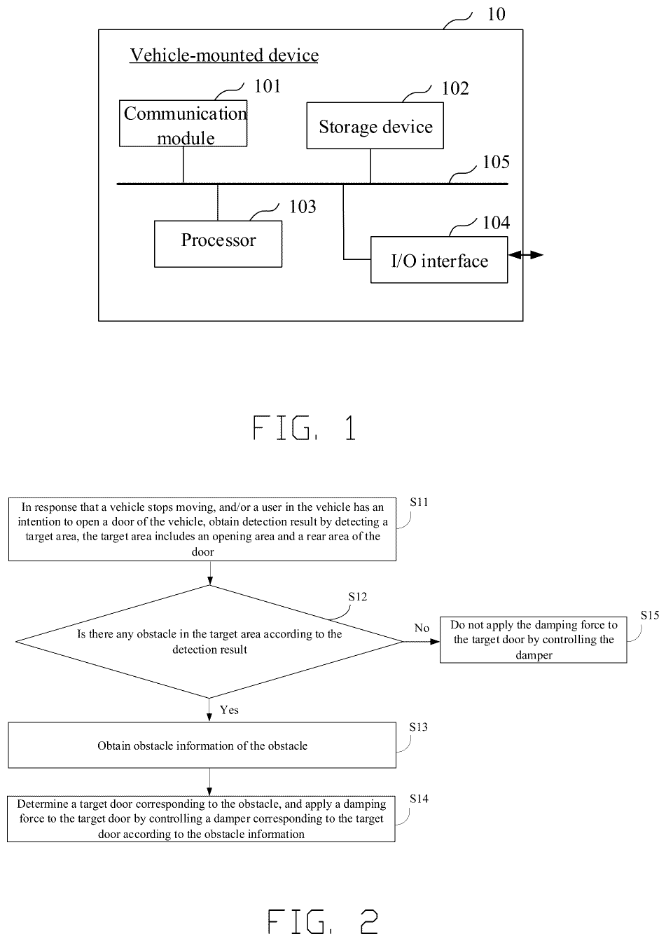

FIG. 2 is a flowchart of a method for controlling doors of a vehicle provided in an embodiment of the present application. According to different requirements, the order of following blocks can be changed, and some blocks can be omitted. The method for controlling doors of a vehicle is applied to a vehicle-mounted device, such as the vehicle-mounted device 10 in FIG. 1.

In block 11, in response that the vehicle-mounted device detects that a vehicle stops moving, and/or a user in the vehicle has an intention to open a door of the vehicle, the vehicle-mounted device obtains detection result by detecting the target area. The target area includes an opening area of each of the doors and a rear area of each of the door.

In one embodiment, the vehicle-mounted device obtains vehicle information, such as a gear of the vehicle, a vehicle speed, or an engine status of the vehicle, and determines whether the vehicle stops moving according to the vehicle information. Specifically, the vehicle-mounted device can obtain the vehicle information by using corresponding sensors. For example, the vehicle-mounted device can obtain a gear of the vehicle by using a gear position sensor, the vehicle-mounted device can obtain the vehicle speed by using a speed sensor. The vehicle-mounted device can obtain the engine status of the vehicle by controlling a Controller Area Network (CAN) interface. For example, in response that the gear of the vehicle can be P gear, the vehicle-mounted device determines that the vehicle stops moving. In response that the vehicle speed is zero, the vehicle-mounted device determines that the vehicle stops moving. In response that an engine status of the vehicle is in a stalled state, the vehicle-mounted device determines that the vehicle stops moving.

In at least one embodiment, the vehicle-mounted device can also determine whether the vehicle stops moving by using other methods. For example, the vehicle-mounted device determines whether the vehicle stops moving by determining whether a vehicle lateral acceleration is zero, and the vehicle-mounted device determines whether the vehicle stops moving by determining whether a wheel velocity of the vehicle is zero.

In at least one embodiment, the vehicle-mounted device (e.g., an electronic control unit) detects and responds to human contact by a touch sensor, and receives a touch signal sent by the touch sensor. The vehicle-mounted device performs actions such as opening the door, closing the door, locking the vehicle, or unlocking the vehicle, based on the touch signal. Generally, the touch sensor is located in a door handle or in areas around the door to detect the user's contact. For example, the touch sensor can include, but is not limited to, a capacitive sensor, a resistive sensor, etc. Specifically, the vehicle-mounted device detects the touch signal by controlling the capacitive sensor according to capacitive sensing principle, and receives the touch signal. The vehicle-mounted device detects the touch signal by controlling the resistive sensor according to resistive sensing principles, and receives the touch signal. Generally, the touch signal can be an electrical signal, which is not specifically limited in these embodiment of the present application.

For example, a surface of the capacitive sensor is covered with an electric field. In response that a finger or other object touches the surface of the capacitive sensor, it changes distribution of the electric field, resulting in changes of capacitance. The vehicle-mounted device controls the capacitive sensor convert capacitance changes into touch signal, and receives the touch signal. In response that a finger or other object touches the surface of the resistive sensor, the vehicle-mounted device can change a resistance value of the resistive sensor. In response that the resistive sensor detects a change in the resistance value, the vehicle-mounted device triggers the touch signal by controlling the resistive sensor, and receives the touch signal.

In at least one embodiment, in response that the vehicle-mounted device receives the touch signal from the touch sensor of the door, the vehicle-mounted device determines that the user has the intention to open the door.

In at least one embodiment, the opening area of the door includes an area covered by the door during an opening process of the door, or an area of the door after the door is opened. The rear area of the door can be a preset area on the rear side of the door, and the rear side of the door can be a direction from the door to the rear of the vehicle. The vehicle-mounted device determines the detection distance by using the sensors of the vehicle (such as a radar, a camera, etc.). For example, in response that the detection distance of the radar is 20 meters, the rear area of the door can be the area within 20 meters behind the door.

In at least one embodiment, the obstacles can include, but is not limited to, vehicles, a pedestrian, an animal, a wall, a street lamp, a stone and a utility pole, for example.

In at least one embodiment, the vehicle-mounted device obtains the detection result by detecting the target area through a plurality of sensors in the vehicle. The plurality of sensors can include, but is not limited to, the radar, a lidar, the camera, a rangefinder. Types of sensors are not limited in embodiments of the present application. For example, in response that the sensor is the camera, the vehicle-mounted device obtains an image by the camera, and determines the image as the detection result. Alternatively, in response that the sensor is the radar or the lidar, the vehicle-mounted device receives an echo signal sent by the radar or lidar, and determines the echo signal as the detection result. Specifically, the echo signal can be a signal reflected back by an electromagnetic wave or an ultrasonic.

In at least one embodiment, the vehicle-mounted device detects whether there is any obstacle in the target area, and a comprehensiveness of detection can be improved.

In block 12, the vehicle-mounted device determines whether there is an obstacle in the target area according to the detection result.

For example, the vehicle-mounted device controls the radar to send an electromagnetic wave signal or an ultrasonic signal to the target area, and receives the echo signal. In response that the intensity of the echo signal is greater than a preset value, the vehicle-mounted device determines there is the obstacle in the target area. For example, the preset value can be set according to a requirement of the door control, the preset value is not specifically limited in this embodiment of the present application.

In at least one embodiment, in response that there is the obstacle in the target area, the vehicle-mounted device obtains obstacle information of the obstacle. In response that there is no obstacle in the target area, the vehicle-mounted device does not apply a damping force to the door of the vehicle.

In block 13, the vehicle-mounted device obtains obstacle information of the obstacle.

In at least one embodiment, the obstacle information can include, but is not limited to, a speed of the obstacle, a position of the obstacle, a category of the obstacle, a height of the obstacle, a width of the obstacle, and a distance between the obstacle and the vehicle, for example.

In at least one embodiment, the vehicle-mounted device can obtain the speed of the obstacle, the position of the obstacle, the height of the obstacle, the width of the obstacle, and the distance between the obstacle and the vehicle according to the radar, the ultrasonic or the lidar. The vehicle-mounted device obtains the image of the obstacle by using a camera device (e.g., cameras of the vehicle, a car driving recorder), and determines a category of the obstacle by recognizing the obstacle image. The vehicle-mounted device obtains a sensor group by randomly combining the plurality of sensors, and obtains the obstacle information by using the sensor group. The electronic device can obtain the obstacle information by using the plurality of sensors, and this is not limited in this application.

In at least one embodiment, for example, the vehicle-mounted device controls the radar to send the electromagnetic wave signal or the ultrasonic signal to the target area, and receives an echo signal. The vehicle-mounted device determines the speed of the obstacle based on a frequency variation between the echo signal and the electromagnetic wave signal. The vehicle-mounted device determines the speed of the obstacle based on the frequency variation between the echo signal and the ultrasonic signal. The vehicle-mounted device determines the height of the obstacle based on an amplitude variation between the echo signal and the electromagnetic wave signal, and the vehicle-mounted device determines the height of the obstacle based on an amplitude variation between the echo signal and the ultrasonic signal. The vehicle-mounted device determines the width of the obstacle based on an amplitude variation between the echo signal and the electromagnetic wave signal, and the vehicle-mounted device determines the width of the obstacle based on an amplitude variation between the echo signal and the ultrasonic signal. The vehicle-mounted device determines the position of the obstacle based on a variation between reception time of the echo signal and transmission time of the electromagnetic wave signal, and the vehicle-mounted device determines the position of the obstacle based on a variation between the reception time of the echo signal and the transmission time of the ultrasonic signal. The vehicle-mounted device determines a distance between the obstacle and the vehicle based on a variation between the reception time of the echo signal and the transmission time of the electromagnetic wave signal, and the vehicle-mounted device determines the distance between the obstacle and the vehicle based on a variation between the reception time of the echo signal and the transmission time of the ultrasonic signal.

In at least one embodiment, the obstacle information may be obtained in another manner, and this is not limited in this application. For example, the vehicle-mounted device can obtain the speed of the obstacle by controlling the rangefinder to measure the distance between the obstacle and the vehicle, or the vehicle-mounted device can obtain the speed of the obstacle by recognizing a plurality of continuously images of the obstacle.

In at least one embodiment, the vehicle-mounted device can obtain comprehensive obstacle information by using the plurality of sensors, and perform precise controls of the door of the vehicle based on the comprehensive obstacle information.

In block 14, the vehicle-mounted device determines a target door corresponding to the obstacle, and applies a damping force to the target door by controlling a damper corresponding to the target door according to the obstacle information.

In at least one embodiment, the target door can be a door closest to the obstacle, or the target door can be a door on the same side as the obstacle. The target door can be one or more. Generally, the vehicle has a plurality of doors, and the obstacle typically affect the opening of some of the plurality of doors. Therefore, the vehicle-mounted can realize precise control of the door by determining the target door corresponding to obstacle.

In at least one embodiment, the damper can be a controllable damper. For example, the damper can be a spring damper, a hydraulic damper, a pneumatic damper, an electromagnetic damper, etc. The vehicle-mounted device applies the damping force to the target door corresponding to the obstacle information, and applies different damping force to the target door according to the different obstacle information.

In at least one embodiment, the vehicle-mounted device applies different damping force to the target door according to the different obstacle information, and controls the target door according to the different damping force, thus achieving flexible and precise controls of the target door.

In at least one embodiment, the vehicle-mounted device may detect the obstacle in real time. In response that there is no obstacle in the target area, the vehicle-mounted device releases the damping force of the target door.

In block 15, the vehicle-mounted device does not apply the damping force to the target door by controlling the damper.

In at least one embodiment, in response that there is no obstacle in the target area, the vehicle-mounted device determines that the door may not collide with the obstacle when the user in the vehicle open the door. Therefore, the vehicle-mounted device does not apply the damping force to the target door by controlling the damper.

In at least one embodiment, in response that the user in the vehicle has an intention to open the door of the vehicle, the vehicle-mounted device detects whether there is any obstacle in the target area, and a comprehensiveness of detection can be improved.

In at least one embodiment, in response that there is the obstacle in the target area of the vehicle, the vehicle-mounted device applies the damping force to the door according to the obstacle information. The vehicle-mounted can effectively prevent the user from operating the door without relying on the reception of a warning signal, thereby effectively reducing accidents caused by the collision of the door of the vehicle when the user in the vehicle open the door.

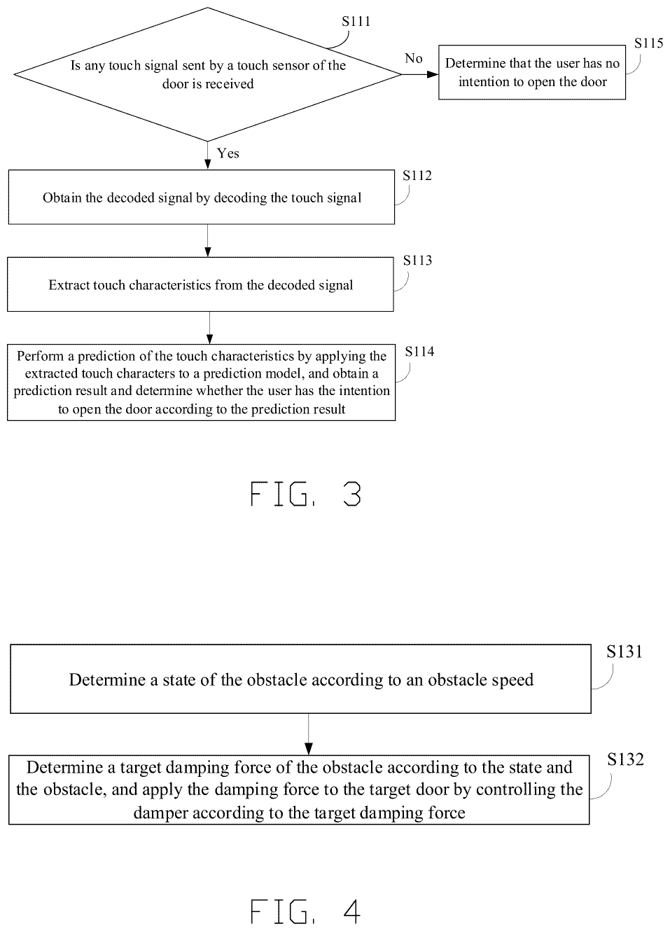

In at least one embodiment, FIG. 3 is a first flowchart of a method for determining an intention to open the door provided in an embodiment of the present application.

In block 111, the vehicle-mounted device determines whether a touch signal sent by a touch sensor of the door is received.

In at least one embodiment, in response that the touch signal is received from the touch sensor of the door, the vehicle-mounted device obtains a decoded signal by decoding the touch signal. In response that no touch signal is received from the touch sensor of the door, the vehicle-mounted device determines that the user has no intention to open the door.

In block 112, the vehicle-mounted device obtains the decoded signal by decoding the touch signal.

In at least one embodiment, the touch signal can be an analog signal or a digital signal. The vehicle-mounted device can perform a filtering process and a denoising process on the touch signal before decoding the touch signal.

In at least one embodiment, after filtering and denoising the touch signal, the vehicle-mounted device obtains the decoded signal by performing a decoding method corresponding to the touch signal to decode the touch signal. For example, in response that the touch signal is the analog signal, the decoding method can include, but is not limited to, an envelope-demodulation method, a coherent detection method, for example. The touch signal is decoded according to a decoding algorithm, and the decoding method can be referred to related technologies, which is not be described in details in this application.

In block 113, the vehicle-mounted device extracts touch characteristics from the decoded signal.

In at least one embodiment, the predict of the touch characteristics include at least one or a combination of a touch position, a touch speed, a touch shape, a touch duration, and a touch intensity.

In at least one embodiment, the vehicle-mounted device obtains the touch characteristics by using various methods. For example, the vehicle-mounted device determines a point where a finger or other object contacts the touch sensor as the touch point, and determines a position of the touch point as the touch position. Each touch point corresponds to a touch position, and each touch point corresponds to a touch time. The vehicle-mounted device calculates a plurality of positional differences between the touch position of any two of the plurality of continuously touch points, and calculates a plurality of time intervals between the touch duration of any two of the plurality of continuously touch points. The vehicle-mounted device determines the touch speed by calculating a value based on each of the plurality of positional differences and each of the plurality of time intervals. The vehicle-mounted device determines a curve or a polygon obtained by connecting the plurality of temporally consecutive touch points as the touch shape. The vehicle-mounted device determines the touch duration by calculating a difference between touch time corresponding to a last touch point and touch time corresponding to a first touch point among the plurality of temporally consecutive touch points.

Temporal continuity indicates that the plurality of time intervals between the touch time of any two consecutive touch points of the plurality of temporally consecutive touch points are the same. Temporal continuity indicates the plurality of time intervals between the touch time of any two consecutive touch points of the plurality of temporally consecutive touch points are within a preset range. The preset range can be set according to a requirement of the door control, the preset range is not specifically limited in this embodiment of the present application. For example, the preset range may be set to be [1, 2]. In response that no touch point is detected within the preset time, the vehicle-mounted device determines the most recently detected touch point as the last touch point. The preset time can be set according to a requirement of the door control, the preset time is not specifically limited in this embodiment of the present application. For example, the preset time may be set to be 8 seconds. The vehicle-mounted device determines a peak of the decoded signal as the touch intensity.

For example, the vehicle-mounted device detected a first touch point at 9:05:10, a second touch point at 9:05:12, a third touch point at 9:05:14, and a fourth touch point at 9:05:24. In response that the preset time may be set to be 8 seconds, the time interval between the touch time of the first touch point and the touch time of the second touch point is 2 seconds, and the time interval between the touch time of the second touch point and the touch time of the third touch point is 2 seconds, the time interval between the touch time of the fourth touch point and the touch time of the third touch point is 10 seconds, which is greater than the preset time of 8 seconds. Therefore, the first touch point, the second touch point, and the third touch point are determined to be temporally consecutive touch points, the vehicle-mounted device calculates the time interval between the touch time of the last touch point at 9:05:14 and the touch time of the first touch point at 9:05:10, and determines the time interval of 4 seconds as the touch duration.

In block 114, the vehicle-mounted device performs a prediction of the touch characteristics by applying the extracted touch characters to a prediction model, and obtains a prediction result and determines whether the user has the intention to open the door according to the prediction result.

In at least one embodiment, the prediction model can include, but is not limited to, a Convolutional Neural Network model, a Recurrent Neural Network model, and a Long Short-Term Memory network model. The prediction model is not specifically limited in this embodiment of the present application.

In at least one embodiment, the prediction model can be trained by using preset touch characteristics and a corresponding user intention of each the preset touch characteristics. The preset touch characteristics can be multiple, and the preset touch characteristics are basically the same as the touch characteristics mentioned above, it is not repeatedly described herein. The user intention can be set according to a requirement of the door control, the user intention is not specifically limited in this embodiment of the present application. For example, the user intention includes at least an intention for opening the door of the vehicle, a false touch, an intention for opening the window of the vehicle, an intention for closing the door of the vehicle, for example.

In at least one embodiment, the quantity correspondence between user intentions and preset touch characteristics can be set according to a requirement of the door control, the quantity correspondence between user intentions and preset touch characteristics is not specifically limited in this embodiment of the present application. For example, one user intention corresponds to one preset touch characteristic, or one user intention corresponds to a plurality of preset touch characteristics.

In at least one embodiment, in response that the prediction result is opening the door of the vehicle, the vehicle-mounted device determines that the user has the intention to open the door.

In at least one embodiment, the prediction model can be trained by using preset touch characteristics and a corresponding user intention of each the preset touch characteristics. Therefore, the vehicle-mounted device determines whether the user has the intention to open the door according to touch characteristics.

In block 115, the vehicle-mounted device determines that the user has no intention to open the door.

In at least one embodiment, in response that no touch signal is received from the touch sensor of the door, it is indicated that the user does not touch the door, and the vehicle-mounted device determines that the user has no intention to open the door.

In at least one embodiment, FIG. 4 is a second flowchart of a method for determining the intention to open the vehicle door provided in an embodiment of the present application.

In block 131, the vehicle-mounted device determines a state of the obstacle according to the obstacle speed.

In at least one embodiment, the state of the obstacle includes a dynamic state and a static state. In response that the obstacle speed is zero, the vehicle-mounted device determines that the state of the obstacle is static. In response that the obstacle speed is not zero, the vehicle-mounted device determines that the state of the obstacle is dynamic.

In block 132, the vehicle-mounted device determines a target damping force of the target door according to the state and the obstacle, and applies the damping force to the target door by controlling the damper according to the target damping force.

In at least one embodiment, in response that the state of the obstacle is dynamic and the obstacle belongs to the first preset category, the vehicle-mounted device determines the first preset damping force corresponding to the first preset category as the target damping force. In response that the state of the obstacle is dynamic and the obstacle belongs to the second preset category, the vehicle-mounted device determines the second preset damping force corresponding to the second preset category as the target damping force. In response that the state of the obstacle is static, the vehicle-mounted device determines the third preset damping as the target damping force.

In at least one embodiment, the first preset category can be vehicles (e.g., a truck, a car, a bicycle, etc.), the second preset category can be people and animals (e.g., a cat, a dog, etc.), and the third preset category can be static objects (e.g., wall, stone, etc.). The first preset damping force corresponding to the first preset category is greater than the second preset damping force corresponding to the second preset category, the second preset damping force corresponding to the second preset category is greater than the third preset damping force corresponding to the third preset category. The first preset damping force, the second preset damping force and the third preset damping force can be set according to a requirement of the door control, the first preset damping force, the second preset damping force and the third preset damping force are not specifically limited in this embodiment of the present application. For example, the first preset damping force may be set to be 3000(N), the second preset damping force may be set to be 1800(N), the third preset damping force 800(N).

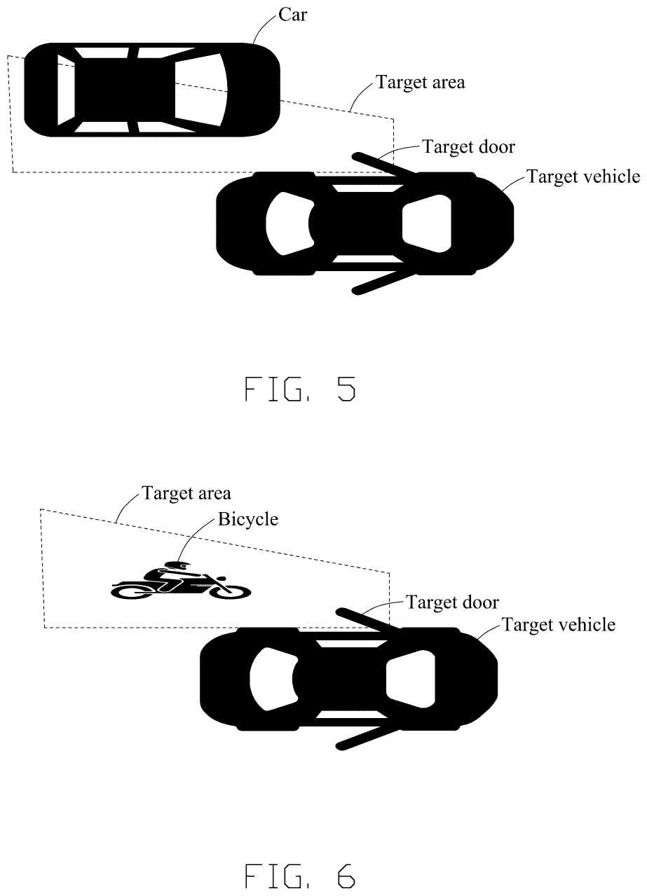

For example, FIG. 5 is a first diagram of a first preset damping force in an embodiment of the present application. An area framed by a dashed-line frame is the target area. In response that the target vehicle stops moving, a car is approaching the target vehicle from a rear position of the target vehicle, and driving towards the position of the target door of the target vehicle. In response that the user in the target vehicle opens the target door and gets out of the target vehicle, the car may be collided with the opening door of the target vehicle or the user, and a traffic accident is caused. If the speed of the car is fast, a probability of occurrence of a dangerous accident is high. In this embodiment, the vehicle-mounted device determines a maximum first preset damping force as the target damping force, and applies the target damping force to the target door by controlling a damper, thus, it is difficult or even impossible for the user to open the target door. Accordingly, a collision between the car and the opening door of the target vehicle or the user can be avoided.

For example, FIG. 6 is a second diagram of the first preset damping force in an embodiment of the present application. In response that the target vehicle stops moving, a bicycle is approaching the target vehicle from the rear position of the target vehicle, and driving towards the position of the target door of the target vehicle. In response that the user in the target vehicle opens the target door and gets out of the target vehicle, the bicycle may be collided with the opening door of the target vehicle or the user, and the traffic accident is caused. If the speed of the bicycle is fast, the probability of occurrence of a dangerous accident is high. In this embodiment, the vehicle-mounted device determines the maximum first preset damping force as the target damping force, and applies the target damping force to the target door by controlling a damper, thus, it is difficult or even impossible for the user to open the target door. Accordingly, the collision between the bicycle and the opening door of the target vehicle or the user can be avoided.

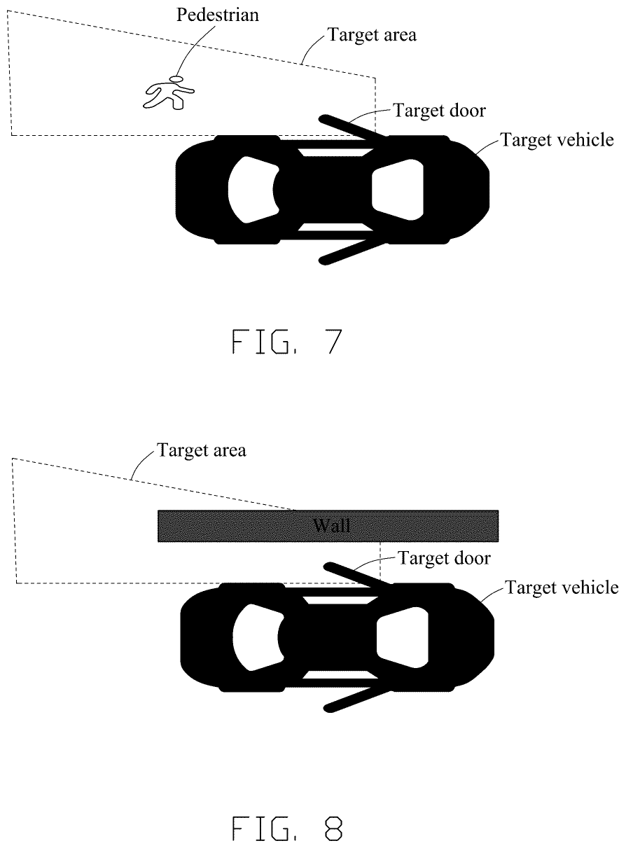

For example, FIG. 7 is a first diagram of a second preset damping force in an embodiment of the present application. In response that the target vehicle stops moving, a pedestrian is approaching the target vehicle from the rear position of the target vehicle, and walking towards the position of the target door of the target vehicle. In response that the user in the target vehicle opens the target door and gets out of the target vehicle, the pedestrian may be collided with the opening door of the target vehicle or the user, and the traffic accident is caused. If the speed of the pedestrian is fast, the probability of occurrence of a dangerous accident is high. In this embodiment, the vehicle-mounted device determines the second preset damping force as the target damping force, and applies the target damping force to the target door by controlling a damper, thus, the user will experience a reduction in the speed of opening the target door. Accordingly, the collision between the pedestrian and the opening door of the target vehicle or the user can be reduced.

In at least one embodiment, the vehicle-mounted device controls the damping force applied by the damper to the target door to reach the target damping force by adjusting a parameter of the damper.

In at least one embodiment, the parameters of the damper can be determined according to the type of damper. For example, in response that the damper can be a hydraulic damper, the parameters of the hydraulic damper can be a flow rate of the liquid, a pressure of the liquid and a viscosity of the liquid, for example. In response that the damper can be a pneumatic damper, the parameters of the pneumatic damper can be a flow rate of the gas, the pressure of the gas, a density of the gas, for example. In response that the damper is an electromagnetic damper, the parameters of the electromagnetic damper can be a strength of an electromagnetic field, an excitation current and a coil.

In at least one embodiment, the vehicle-mounted device applies the first preset damping force to the target door by controlling the damper, thus, it is difficult or even impossible for the user to open the target door, thereby the door of the vehicle collision accidents caused by user in the vehicle opening the target door are effectively avoided. The vehicle-mounted device applies the second preset damping force to the target door by controlling the damper, the user feels greater resistance when opening the target door, the greater resistance can effectively warn the user and reduce the speed at which the user opens the target door, thereby effectively avoiding collision accidents caused by users in the vehicle when opening the target door. The vehicle-mounted device applies the third preset damping force to the target door by controlling the damper, the user feels greater resistance when opening the target door, the greater resistance can effectively warn the user, thereby effectively avoiding collision accidents caused by users in the vehicle when opening the target door.

In at least one embodiment, in response that the state of the obstacle is static, the vehicle-mounted device calculates an opening angle of the target door according to a door parameter of the target door and a distance between the obstacle and the target door, and controls the opening of the target door according to the opening angle.

In at least one embodiment, the door parameters of the target door include, but are not limited to, a height of the target door and a width of the target door. The distance between the obstacle and the target door is a horizontal distance. The opening angle may be calculated by following Equation (1):

$$θ = arctan ( \frac{( W / 2 )}{( D + H / 2 )} ) , \qquad ( 1 )$$

in the Equation (1), θ is the opening angle, W is the width of the target door, Dis the distance between the obstacle and the target door, His the height of the target door.

In at least one embodiment, the vehicle-mounted device can also calculate the opening angle using other methods, which are not limited in any embodiment.

FIG. 8 is a second diagram of a third preset damping force in an embodiment of the present application. In response that the target vehicle is parked nearby a wall, and a distance between the target vehicle and the wall is small, for example, the distance is within a predetermined range. In response that the target door of the target vehicle is fully opened, the opening of the target door may collide with the wall, thereby causing damage to the door. In one embodiment, the vehicle-mounted device applies the third preset damping force to the target door by controlling the damper, and controls the opening of the target door according to the opening angle. Therefore, the collision between the target door and the wall, and the damage of the target door can be effectively avoided.

In at least one embodiment, the opening angle can be the maximum opening angle of the door calculated based on the parameters of the target door and the distance between the obstacle and the target door. The vehicle-mounted device controls the opening of the target door according to the opening angle, for preventing the opening of the target door from hitting the wall. Therefore, the collision between the target door and the wall, and the damage of the target door can be effectively avoided.

In at least one embodiment, the vehicle-mounted device can also warn users through voice and light.

A computer-readable storage medium is also provided in the present disclosure. A computer program is stored on the computer-readable storage medium. The computer program includes program instructions. A method implemented when the program instructions are executed may refer to methods in above-mentioned embodiments of this disclosure.

The computer-readable storage medium may be an internal memory of the vehicle-mounted device described in the above embodiment, such as a hard disk or memory of the vehicle-mounted device. The computer-readable storage medium may also be an external storage device of the vehicle-mounted device, such as a plug-in hard disk, a Smart Media Card (SMC), or a Secure Digital (SD) card, a Flash Card, etc. equipped on the vehicle-mounted device.

In some embodiments, the computer-readable storage medium may include a storage program area and a storage data area, wherein the storage program area may store an operating system, at least one application program required for a function, etc. The storage data area may store data created based on an use of the vehicle-mounted device, etc.

In the above embodiments, each embodiment is described with its own emphasis. For parts that are not detailed or documented in a certain embodiment, please refer to relevant descriptions of other embodiments.

In the several embodiments provided in the preset disclosure, the disclosed vehicle-mounted device and method can be implemented in other ways. For example, the embodiments of the devices described above are merely illustrative. For example, a division of the modules is based on logical function only, and there can be other manners of division in actual implementation.

The modules described as separate components may or may not be physically separated, and the components displayed as modules may or may not be physical units. That is, it can be located in one place, or distributed to multiple network units. Some or all of the modules can be selected according to actual needs to achieve the purpose of the solution of above embodiments.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names, but not in any particular order.

Finally, the above embodiments are only used to illustrate technical solutions of the present disclosure, rather than restrictions on the technical solutions. Although the present disclosure has been described in detail with reference to the above embodiments, those skilled in the art should understand that the technical solutions described in one embodiments can be modified, or some of technical features can be equivalently substituted, and these modifications or substitutions are not to detract from the essence of the corresponding technical solutions or from the scope of the technical solutions of the embodiments of the present disclosure.

What is claimed is:

1. A method for controlling doors of a vehicle, the method comprising:
in response that a vehicle stops moving, and/or a user in the vehicle has an intention to open a door of the vehicle, detecting whether there is an obstacle in a target area of the vehicle, the target area comprising an opening area of each of the doors and a rear area of each of the doors;
in response that there is the obstacle in the target area of the vehicle, obtaining obstacle information of the obstacle;
determining a target door corresponding to the obstacle, and applying a damping force to the target door by controlling a damper corresponding to the target door according to the obstacle information.

2. The method of claim 1, wherein determining whether a user in the vehicle has an intention to open a door of the vehicle comprises:
in response that a touch signal is received from a touch sensor of the door, determining that the user has the intention to open the door.

3. The method of claim 2, wherein determining whether a user in the vehicle has an intention to open a door of the vehicle further comprises:
in response that the touch signal is received from the touch sensor of the door, obtaining a decoded signal by decoding the touch signal;
extracting touch characteristics from the decoded signal;
performing a prediction of the touch characteristics by applying the extracted touch characters to a prediction model, obtaining a prediction result and determining whether the user has the intention to open the door according to the prediction result, the prediction model being trained by applying preset touch characteristics and a corresponding user intention of each the preset touch characteristics.

4. The method of claim 3, wherein the prediction of the touch characteristics comprises at least one or a combination of a touch position, a touch speed, a touch shape, a touch duration, and a touch intensity.

5. The method of claim 1, wherein the obstacle information comprises an obstacle speed, applying a damping force to the target door by controlling a damper corresponding to the target door according to the obstacle information comprises:
determining a state of the obstacle according to the obstacle speed;
determining a target damping force of the target door according to the state and the obstacle, and applying the damping force to the target door by controlling the damper according to the target damping force.

6. The method of claim 5, wherein the target damping force of the obstacle is determined according to one of the following conditions:
in response that the state of the obstacle is dynamic and the obstacle belongs to a first preset category, determining a first preset damping force corresponding to the first preset category as the target damping force;
in response that the state of the obstacle is dynamic and the obstacle belongs to a second preset category, determining a second preset damping force corresponding to the second preset category as the target damping force;
in response that the state of the obstacle is static, determining a third preset damping as the target damping force.

7. The method of claim 1, wherein applying the damping force to the target door by controlling the damper according to the target damping force comprises:
controlling the damping force applied by the damper to the target door to reach the target damping force by adjusting a parameter of the damper.

8. The method of claim 6, further comprising:
in response that the state of the obstacle is static, calculating an opening angle of the target door according to a door parameter of the target door and a distance between the obstacle and the target door, and controlling the opening of the target door according to the opening angle.

9. A vehicle-mounted device comprising:
a processor; and
a storage device that stories a plurality of instructions, which when executed by the processor, cause the processor to:
in response that a vehicle stops moving, and/or a user in the vehicle has an intention to open a door of the vehicle, detect whether there is an obstacle in a target area of the vehicle, the target area comprising an opening area of each of the doors and a rear area of each of the door;
in response that there is the obstacle in the target area of the vehicle, obtain obstacle information of the obstacle;
determine a target door corresponding to the obstacle, and apply a damping force to the target door by controlling a damper corresponding to the target door according to the obstacle information.

10. The vehicle-mounted device of claim 9, wherein the processor is further caused to:
in response that a touch signal is received from a touch sensor of the door, determine that the user has the intention to open the door.

11. The vehicle-mounted device of claim 10, wherein the processor is further caused to:
in response that the touch signal is received from the touch sensor of the door, obtain a decoded signal by decoding the touch signal;
extract touch characteristics from the decoded signal;
perform a prediction of the touch characteristics by applying the extracted touch characters to a prediction model, obtain a prediction result and determining whether the user has the intention to open the door according to the prediction result, the prediction model being trained by applying preset touch characteristics and a corresponding user intention of each the preset touch characteristics.

12. The vehicle-mounted device of claim 11, wherein the prediction of the touch characteristics comprises at least one or a combination of a touch position, a touch speed, a touch shape, a touch duration, and a touch intensity.

13. The vehicle-mounted device of claim 9, wherein the obstacle information comprises an obstacle speed, the processor is further caused to:
determine a state of the obstacle according to the obstacle speed;
determine a target damping force of the target door according to the state and the obstacle, and apply the damping force to the target door by controlling the damper according to the target damping force.

14. The vehicle-mounted device of claim 13, wherein the target damping force of the obstacle is determined according to one of the following conditions:
in response that the state of the obstacle is dynamic and the obstacle belongs to a first preset category, determine a first preset damping force corresponding to the first preset category as the target damping force;
in response that the state of the obstacle is dynamic and the obstacle belongs to a second preset category, determine a second preset damping force corresponding to the second preset category as the target damping force;
in response that the state of the obstacle is static, determine a third preset damping as the target damping force.

15. A non-transitory storage medium having stored thereon at least one computer-readable instructions that, when executed by a processor of a vehicle-mounted device, causes the processor to perform a method for controlling doors of a vehicle, the method comprising:
in response that a vehicle stops moving, and/or a user in the vehicle has an intention to open a door of the vehicle, detecting whether there is an obstacle in a target area of the vehicle, the target area comprising an opening area of each of the doors and a rear area of each of the doors;
in response that there is the obstacle in the target area of the vehicle, obtaining obstacle information of the obstacle;
determining a target door corresponding to the obstacle, and applying a damping force to the target door by controlling a damper corresponding to the target door according to the obstacle information.

16. The non-transitory storage medium of claim 15, wherein determining whether a user in the vehicle has an intention to open a door of the vehicle comprises:
in response that a touch signal is received from a touch sensor of the door, determining that the user has the intention to open the door.

17. The non-transitory storage medium of claim 16, wherein determining whether a user in the vehicle has an intention to open a door of the vehicle further comprises:
in response that the touch signal is received from the touch sensor of the door, obtaining a decoded signal by decoding the touch signal;
extracting touch characteristics from the decoded signal;
performing a prediction of the touch characteristics by applying the extracted touch characters to a prediction model, obtaining a prediction result and determining whether the user has the intention to open the door according to the prediction result, the prediction model being trained by applying preset touch characteristics and a corresponding user intention of each the preset touch characteristics.

18. The non-transitory storage medium of claim 17, wherein the prediction of the touch characteristics comprises at least one or a combination of a touch position, a touch speed, a touch shape, a touch duration, and a touch intensity.

19. The non-transitory storage medium of claim 15, wherein the obstacle information comprises an obstacle speed, applying a damping force to the target door by controlling a damper corresponding to the target door according to the obstacle information comprises:
determining a state of the obstacle according to the obstacle speed;
determining a target damping force of the target door according to the state and the obstacle, and applying the damping force to the target door by controlling the damper according to the target damping force.

20. The non-transitory storage medium of claim 19, wherein the target damping force of the obstacle is determined according to one of the following conditions:
in response that the state of the obstacle is dynamic and the obstacle belongs to a first preset category, determining a first preset damping force corresponding to the first preset category as the target damping force;
in response that the state of the obstacle is dynamic and the obstacle belongs to a second preset category, determining a second preset damping force corresponding to the second preset category as the target damping force;
in response that the state of the obstacle is static, determining a third preset damping as the target damping force.
